(19) United States
(12) Patent Application Publication
(10) Pub. No.: US 2022/0252725 A1
(43) Pub. Date: Aug. 11, 2022

(54) Lidar Sensor with Dynamic Projection Patterns

(71) Applicant: Artilux, Inc., Menlo Park, CA (US)

(72) Inventors: Hung-Chih Chang, HSINCHU COUNTY (TW); Der-Song Lin, HSINCHU COUNTY (TW); Yun-Chung Na, SAN JOSE, CA (US)

(21) Appl. No.: 17/665,093

(22) Filed: Feb. 4, 2022

Related U.S. Application Data
(60) Provisional application No. 63/145,988, filed on Feb. 5, 2021.

(51) Int. Cl. G01S 17/08; G01S 7/48; G01S 7/4912

(52) U.S. Cl. CPC G01S 17/08; G01S 7/4918; G01S 7/4808

(57) ABSTRACT

Systems and methods for sensing objects are provided. An optical apparatus can include a transmitter configured to project on a surface of an object, a first optical pattern having a first set of characteristics and a second optical pattern having a second set of characteristics. The optical apparatus can include a receiver configured to receive first and second reflected optical patterns representing a reflection of the first optical pattern and the second optical pattern from the surface of the object, and generate first and second electrical signals representing the first and the second reflected optical patterns. The optical apparatus can include one or more processors configured to receive the first electrical signals and the second electrical signals, and determine one or more characteristics of the object, including range information of the object.

### PRIORITY CLAIM

The present application claims benefit of U.S. Provisional Patent Application Ser. No. 63/145,988 having a filing date of Feb. 5, 2021, which is incorporated herein by reference in its entirety.

### FIELD

The present disclosure relates generally to sensor apparatuses. In particular, the present disclosure relates to a Lidar with multiple projection patterns.

### BACKGROUND

A light detection and ranging (Lidar) sensor is a device, module, machine, subsystem, or system with a purpose to detect range information (e.g., how far an object is from the lidar) of objects in its environment and send the information to other electronics. Lidar can be used in many applications, including automotive, robotics, consumer electronics (e.g., mobile, wearable, or portable devices), and many other suitable applications.

### SUMMARY

Aspects and advantages of embodiments of the present disclosure will be set forth in part in the following description, or may be learned from the description, or may be learned through practice of the embodiments.

One example aspect of the present disclosure is directed to an optical apparatus including a transmitter configured to project on a surface of an object, a first optical pattern having a first set of characteristics; and project on the surface of the object, a second optical pattern having a second set of characteristics that are different from the first set of characteristics. The optical apparatus further includes a receiver configured to receive a first reflected optical pattern representing a reflection of the first optical pattern from the surface of the object; generate first electrical signals representing the first reflected optical pattern; receive a second reflected optical pattern representing a reflection of the second optical pattern from the surface of the object; and generate second electrical signals representing the second reflected optical pattern. The optical apparatus further includes one or more processors configured to receive the first electrical signals and the second electrical signals; and determine, based on the first electrical signals and the second electrical signals, one or more characteristics of the object, where the one or more characteristics include range information of the object.

Another example aspect of the present disclosure is directed to a method for operating an optical apparatus including projecting, by a transmitter, a first optical pattern having a first set of characteristics onto a surface of an object; projecting, by the transmitter, a second optical pattern having a second set of characteristics that are different from the first set of characteristics onto the surface of the object; receiving, by a receiver, a first reflected optical pattern representing a reflection of the first optical pattern from the surface of the object; generating, by the receiver, first electrical signals representing the first reflected optical pattern; receiving, by the receiver, a second reflected optical pattern representing a reflection of the second optical pattern from the surface of the object; generating, by the receiver, second electrical signals representing the second reflected optical pattern; and determining, by one or more processors and based on the first electrical signals and the second electrical signals, one or more characteristics of the object, where the one or more characteristics include range information of the object.

Another example aspect of the present disclosure is directed to a light detection and ranging (LIDAR) device including a transmitter configured to project on a surface of an object, a first optical pattern having a first dot density; and project on the surface of the object, a second optical pattern having a second dot density that is different from the first dot density. The LIDAR device further includes a germanium-based receiver formed on a silicon substrate, the germanium-based receiver configured to receive a first reflected optical pattern representing a reflection of the first optical pattern from the surface of the object; generate first electrical signals representing the first reflected optical pattern; receive a second reflected optical pattern representing a reflection of the second optical pattern from the surface of the object; and generate second electrical signals representing the second reflected optical pattern. The LIDAR device further includes silicon-based control circuitry configured to control the transmitter or the germanium-based receiver. The LIDAR device further includes one or more processors configured to receive the first electrical signals and the second electrical signals; and determine, based on the first electrical signals and the second electrical signals, one or more characteristics of the object, where the one or more characteristics include range information of the object.

Other example aspects of the present disclosure are directed to systems, methods, apparatuses, sensors, computing devices, tangible, non-transitory computer-readable media, and memory devices.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

The details of one or more embodiments of the subject matter described in this specification are set forth in the accompanying drawings and the description below. Other features, aspects, and advantages of the subject matter will become apparent from the description, the drawings, and the claims.

FIG. 1A and FIG. 1B illustrate examples of a lidar system.

FIG. 2 illustrates an example of a transmitter.

FIG. 3A and FIG. 3B illustrate examples of an optical dot pattern.

FIG. 4 illustrates an example process for operating a lidar system.

FIGS. 5A-5C illustrate examples for operating a lidar system.

FIG. 6 illustrates an example of a germanium-on-silicon sensor device.

### DETAILED DESCRIPTION

A light detection and ranging (Lidar) sensor is a device, module, machine, subsystem, or system with a purpose to detect range information (e.g., how far an object is from the lidar) of objects in its environment and send the information to other electronics. Lidar can be used in many applications, including automotive, robotics, consumer electronics (e.g., mobile, wearable, or portable devices), and many other suitable applications.

In some implementations, a lidar may flood (or flash, to be used interchangeably) a targeted scene (e.g., a portion of a sidewalk) with an optical pattern (e.g., a pattern of dots) to simultaneously get multiple detection points of the targeted scene. To increase the distance of 3D seeable range, the flood laser may transmit a dot pattern to concentrate the part of flood laser power while keeping a wide field of view (FOV). For example, a flood laser may have a peak power of 1 W with a spot size (e.g., area of the illumination) of A. If the area A is concentrated to 1/10 while maintaining the flood laser's peak power, the intensity (e.g., W/m²) of the light will increase by 10 times, as the dot density of the light has increased by 10 times. Such increase in dot density could improve the sensitivity at the receiver side (as there are more photons reflecting from a same area), but the resolution of the result (e.g., point cloud) could decrease (as photons will be concentrated to a smaller area, and the distance between two dots will increase).

To solve the low-resolution issue, some users use the algorithm to stitch the low-resolution information leveraging the SLAM (Simultaneous Localization and Mapping) technique. However, the SLAM algorithm assumes that most objects are static, and it may not be accurately applied on moving objects.

This disclosure describes utilizing multiple projector patterns generated either from a single transmitter with a tunable diffuser, or from multiple transmitters, to extend the seeable range and to compensate low resolution. For example, by combining the benefits of a first pattern with high power density/low flood area and a second pattern with low power density/high flood area, a lidar system can extend its detectable range while keeping high resolution for detecting closer-by objects. Moreover, by leveraging the benefit of a wide bandwidth photodetector such as a germanium-on-silicon (GeSi) photodetector, a lidar system may use a first transmitter having a first wavelength (e.g., 940 nm) to keep an overall low power consumption, and also use a second transmitter having a second wavelength (e.g., 1380 nm, which has a much lower absorption coefficient for the human eyes) capable of emitting a higher power to extend seeable range while keeping eye safety.

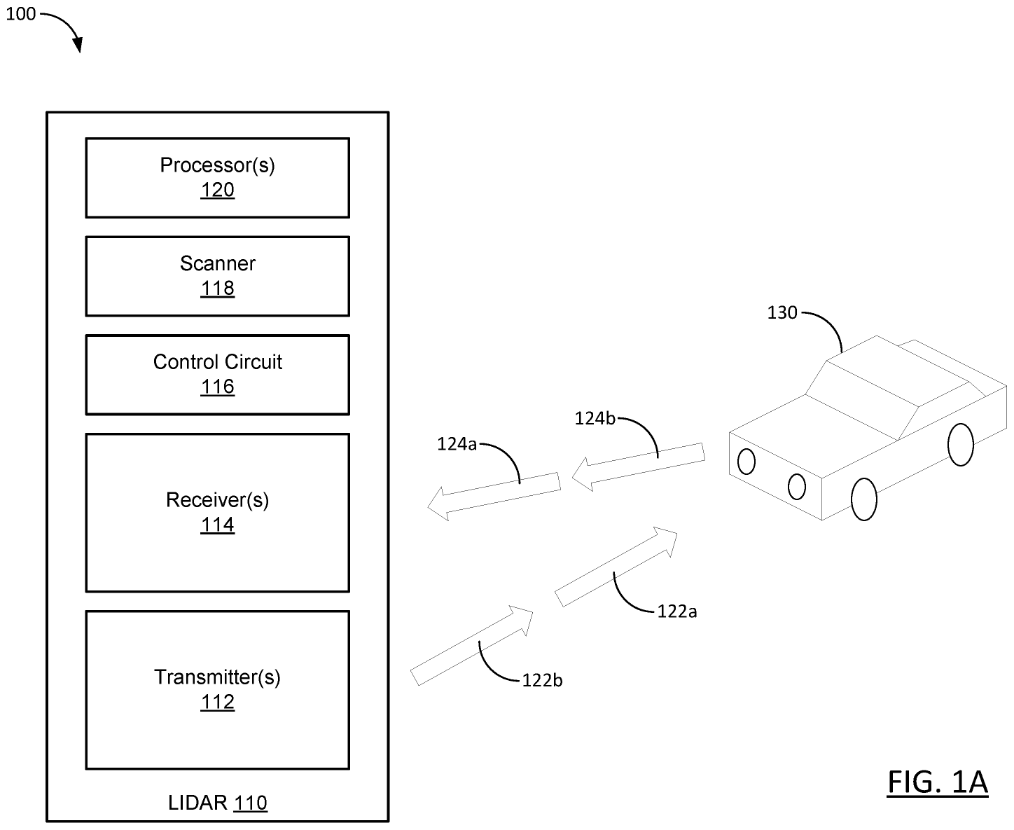

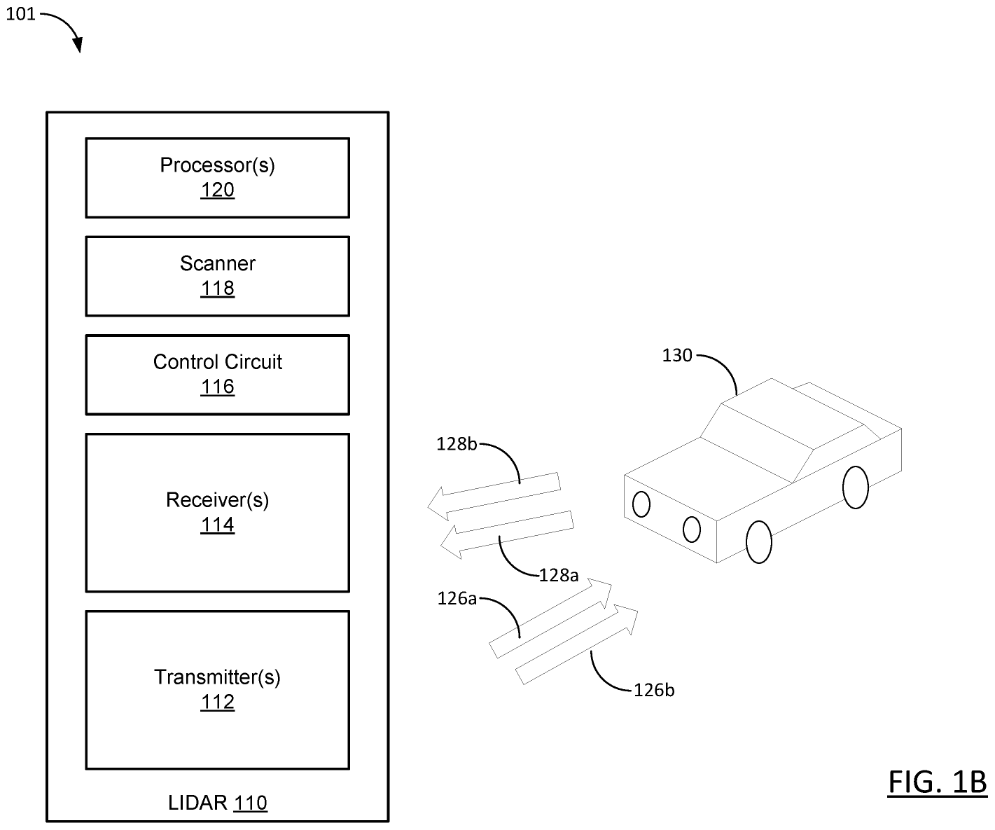

FIG. 1A shows an example of a system 100 that includes a lidar system 110 and a target object 130. The lidar system 110 includes one or more transmitters 112, one or more receivers 114, control circuitry 116, a scanner 118, and one or more processors 120.

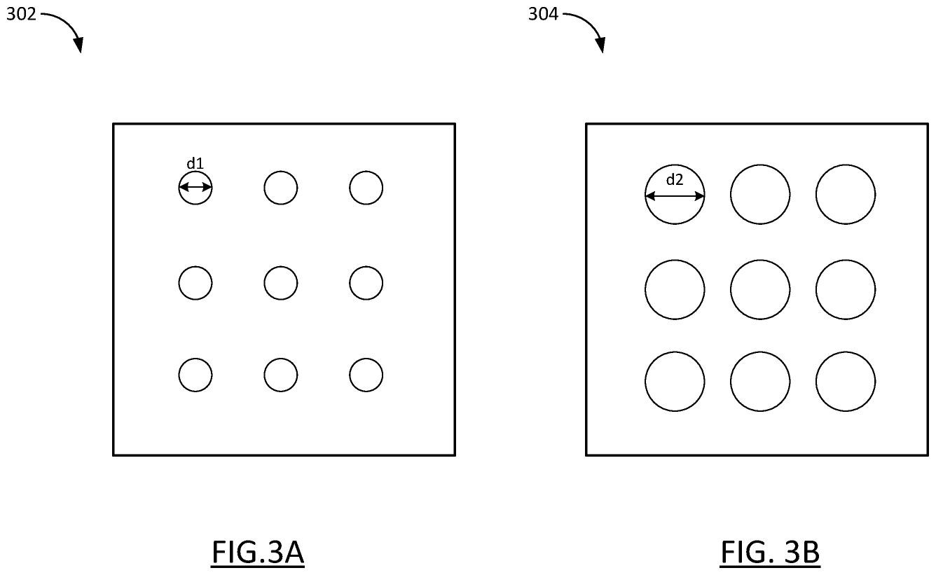

Each of the one or more transmitters 112 can include one or more laser sources for emitting optical signals with a specific wavelength or multiple wavelengths (e.g., visible, near infrared (NIR, e.g., wavelength range from 780 nm to 1400 nm, or any similar wavelength range as defined by a particular application), short-wave infrared (SWIR, e.g., wavelength range from 1400 nm to 3000 nm, or any similar wavelength range as defined by a particular application), etc.). The one or more transmitters 112 are configured to project on a surface of the target object 130, a first optical pattern having a first set of characteristics. For example, the one or more transmitters 112 may emit an optical signal 122a towards the target object 130. The optical signal 122a may have an optical pattern such as a dot pattern as described in reference to FIG. 3A.

The one or more transmitters 112 are configured to project on the surface of the target object 130, a second optical pattern having a second set of characteristics that are different from the first set of characteristics. For example, the one or more transmitters 112 may emit an optical signal 122b towards the target object 130. The optical signal 122b may have another optical pattern such as a dot pattern as described in reference to FIG. 3B, where the density of the dot is different.

The first set of characteristics and the second set of characteristics may include a dot density of the dot pattern. Referring to FIG. 3A, a surface (e.g., a surface on the target object 130) is illuminated with a first dot pattern 302, where a diameter of each dot is designated as d1. Referring to FIG. 3B, the surface is illuminated with a second dot pattern 304, where a diameter of each dot is designated as d2 that is larger than d1. Each dot in a dot pattern has a dot density representing the number of photons hitting the dot within a given time (e.g., Joule per second per unit area). Assuming that the output laser power of the transmitter 112 is the same for generating both the first dot pattern 302 and the second dot pattern 304, the first dot pattern density would be higher than the second dot pattern density. A dot pattern having a higher dot density (e.g., the first dot pattern 302) generally provides a higher detection range for a lidar system, as there is a better chance that a photon will be reflected back to the receiver for a given spot on an object surface. By contrast, a dot pattern having a lower dot density (e.g., the second dot pattern 304) generally provides a higher resolution, as the dot covers more areas on the object surface.

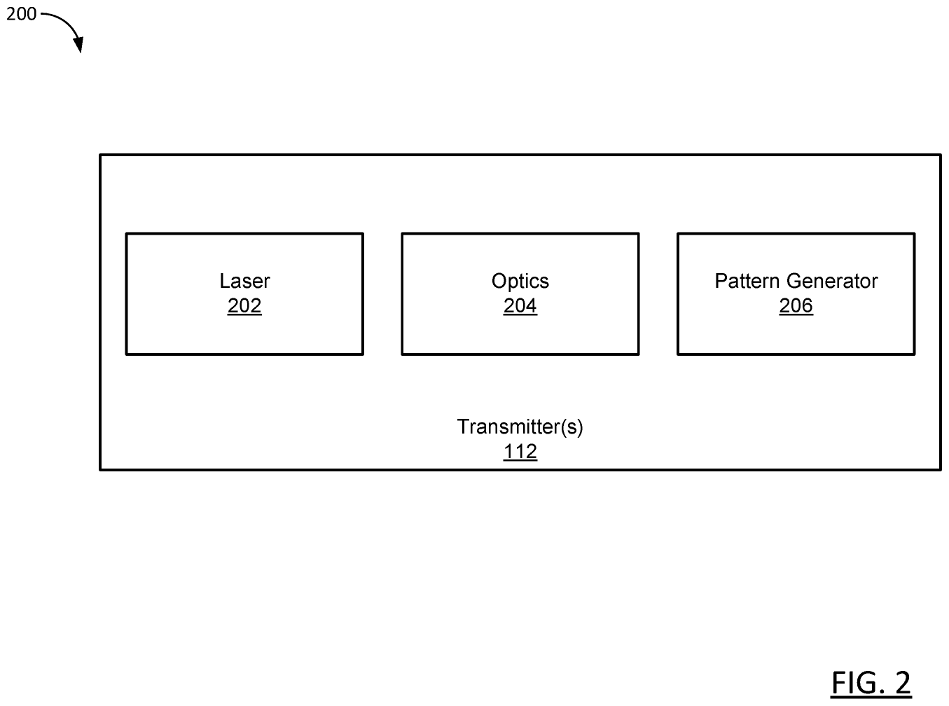

Referring to FIG. 2, a dot pattern may be generated by a combination of one or more lasers 202, passive optics 204, and a pattern generator 206. As an example, after the laser 202 emits an optical signal, the passive optics 204 may collimate the optical signal and guide the collimated optical signal to the diffuser 204. In some implementations, the pattern generator 206 may be a diffuser. The diffuser may be implemented using liquid crystal or phase delay, such that a dot pattern may be formed at the illumination plane (e.g., surface of an object) at the same time. In some other implementations, the pattern generator 206 may be a scanner-based system (e.g., MEMS-based or rotational mirror-based), where a dot pattern may be formed at the illumination plane over a period of time (e.g., within one image frame).

In some implementations, the pattern generator 206 may be dynamically controlled to form different patterns (e.g., a dot pattern with different dot densities) at different time intervals based on one or more control signals. For example, the pattern generator 206 may be controlled to form a dot pattern having a higher dot density (e.g., the first dot pattern) during a first time interval (e.g., 0 to 10 msec), and may then be controlled to form a dot pattern having a lower dot density (e.g., the second dot pattern) during a second time interval (e.g., 10 msec to 20 msec).

Referring back to FIG. 1A, each of the one or more receivers 114 can include one or more photodetectors (e.g., photodiodes, time-of-flight (ToF) sensors, avalanche photodetectors (APD), single-photon avalanche diode (SPAD), etc.) for receiving optical signals with a specific wavelength or multiple wavelengths (e.g., visible, near infrared (NIR), short-wave infrared (SWIR), etc.). The photodetector(s) may be discrete (e.g., a single photodiode) or an integrated array (e.g., a 1-D or 2-D array). The one or more receivers 114 are configured to receive a first reflected optical pattern representing a reflection of the first optical pattern from the surface of the target object 130, and to generate first electrical signals representing the first reflected optical pattern. For example, a photodetector array of the one or more receivers 114 may receive a reflected optical pattern 124a that has been reflected from the target object 130. In response to receiving the reflected optical pattern 124a, the photodetector array may generate first electrical signals (e.g., currents) representing the reflected optical pattern 124a.

The one or more receivers 114 are configured to receive a second reflected optical pattern representing a reflection of the second optical pattern from the surface of the target object 130, and to generate second electrical signals representing the second reflected optical pattern. For example, a photodetector array of the one or more receivers 114 may receive a reflected optical pattern 124b that has been reflected from the target object 130. In response to receiving the reflected optical pattern 124b, the photodetector array may generate second electrical signals (e.g., currents) representing the reflected optical pattern 124b.

The control circuit 116 is configured to control the transmitter(s) 112 and the receiver(s) 114. For example, the control circuit 116 may control a power level of the transmitter(s) 112, or may issue control signals to modulate the optical signals of the transmitter(s) 112. As another example, the control circuit 116 may issue control signals to control a timing of readouts at the receiver(s) 114. In some implementations, the control circuit 116 may be formed monolithically with the transmitter(s) 112 and/or the receiver(s) 114. In some other implementations, the control circuit 116 may be formed separately (e.g., using a CMOS fabrication process) and then coupled (e.g., wire-bond, wafer bonding, etc.) with the transmitter(s) 112 and/or the receiver(s) 114.

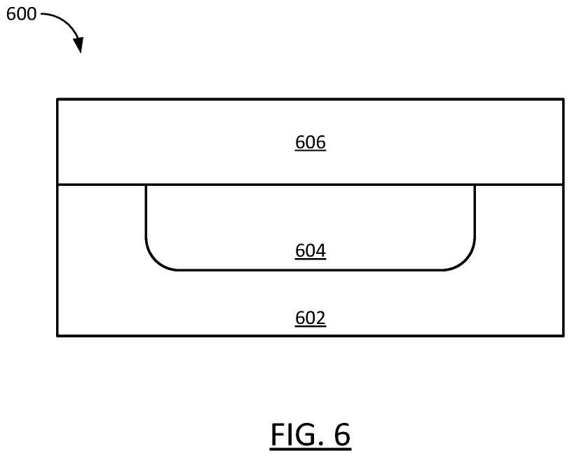

Referring to FIG. 6, an example photodetector 600 is formed on a substrate of a first material (e.g., silicon). The photodetector 600 may be a single photodiode (e.g., linear photodiode, APD, SPAD, etc.), or a pixel of a germanium-on-silicon-based pixel array configured to receive the first reflected optical pattern and the second reflected optical pattern. The photodetector 600 includes an absorption region 604 of a different material (e.g., germanium) for receiving an optical signal to generate electrical signals (e.g., electrons or holes). In some implementations, the photodetector 600 may be bonded to a different substrate 606 (e.g., silicon wafer), where control circuit (e.g., control circuit 116) has been formed on the substrate 606. The photo-generated electrical signals from the absorption region 604 may be read by the control circuit either through the absorption region 604 or through the substrate 602, depending on the photodetector design and operation.

Referring back to FIG. 1A, the scanner 118 is configured to scan optical signals transmitted by the transmitter(s) 112 over time to obtain a representation of a three-dimensional environment. In some implementations, the scanner 118 may include a MEMS mirror (or MEMS mirror array) that's integrated with the transmitter(s) 112. In some other implementations, the scanner 118 may include a discrete optical mirror or prism. The scanner 118 may be controlled together with the pattern generator 206. In some other implementations, the lidar system 110 may not include a scanner. For example, the lidar system 110 may be integrated inside a consumer electronics device, and therefore a scanning function would not be needed. As another example, the lidar system 110 may be arranged on a vehicle to detect the environment along a fixed orientation.

The one or more processors 120 may include hardware circuitry (e.g., FPGA, PCB, CPU, etc.) and/or computer storage medium (e.g., memories) that may store instructions for performing computational tasks. The one or more processors 120 are configured to receive the first electrical signals and the second electrical signals, and determine, based on the first electrical signals and the second electrical signals, one or more characteristics of the target object 130, where the one or more characteristics include range information of the object.

As one example, the processor(s) 120 may determine first range information of the target object 130 based on the first electrical signals that are generated by the first optical pattern having a higher dot density. The processor(s) 120 may then determine second range information of the object based on the second electrical signals that are generated by the second optical pattern having a lower dot density but larger dot size. The processor(s) 120 may then adjust the second range information based on the first range information. In one example scenario, the higher concentration dot would get better signals with less noise, and the lower concentration of dot would get higher spatial resolution but worse signals. The processor(s) 120 may use the first range information having a lower noise to compensate the noise level of the second range information having high spatial resolution, such that a high spatial resolution 3D image with a lower noise may be example generated. In another example scenario, the higher concentration dot may result in over-exposure (or saturation due to high optical intensity) at the receiver(s) 114, and the processor(s) 120 may use the lower concentration of dot to correct or compensate the first range information, such that a high spatial resolution 3D image with a higher dynamic range may be generated by the processor(s) 120.

As another example, after obtaining the first range information and the second range information, the processor(s) 120 may then select, based on one or more selection criteria, one of the first range information or the second range information to determine the characteristics of the target object 130. The selection criteria may include a sensitivity of the receiver, a saturation level of the receiver, and/or a dark current of the receiver. In one example scenario, if the target object 130 is beyond the detectable range of the lower concentration dot pattern, the lower concentration dot may result in a high noise level at the receiver(s) 114. In response to determining that the noise level associated with the lower concentration dot pattern exceeds a threshold, the processor(s) 120 may use only the higher concentration dot pattern to determine the depth information of the target object.

FIG. 1B illustrate an example of another system 101 that is similar as the system 100 as described in reference to FIG. 1A. Here, the transmitter(s) 112 of the lidar system 110 may include one or more first lasers configured to transmit optical signals for the first optical pattern, and one or more second lasers configured to transmit optical signals for the second optical pattern. In some implementations, the first laser(s) and the second laser(s) may transmit optical signals having the same wavelength. In some other implementations, the first laser(s) may transmit optical signals having a first wavelength (e.g., 940 nm), while the second laser(s) may transmit optical signals having a second wavelength (e.g., 1310 nm). The receiver(s) 114 may be divided into multiple regions for receiving optical signals having different wavelengths. For example, the receiver(s) 114 may include a first germanium-on-silicon pixel array optically coupled to a first filter (e.g., a bandpass filter designed to pass the first wavelength) in order to receive a reflected optical pattern having the first wavelength. The receiver(s) 114 may further include a second germanium-on-silicon pixel array optically coupled to a second filter (e.g., a bandpass filter designed to pass the second wavelength) in order to receive a reflected optical pattern having the second wavelength. The processor(s) 120 may process the electrical signals collected from the first and second germanium-on-silicon pixel arrays to determine a characteristic of the target object 130 as described in reference to FIG. 1A. Operating two (or more) wavelengths at the same time can be beneficial in certain weather conditions, where one wavelength may have a lower water absorption coefficient than the other wavelength, and therefore would enhance the operability of certain applications (e.g., autonomous driving). As another example, operating two (or more) wavelengths at the same time can enable other applications such as material classification.

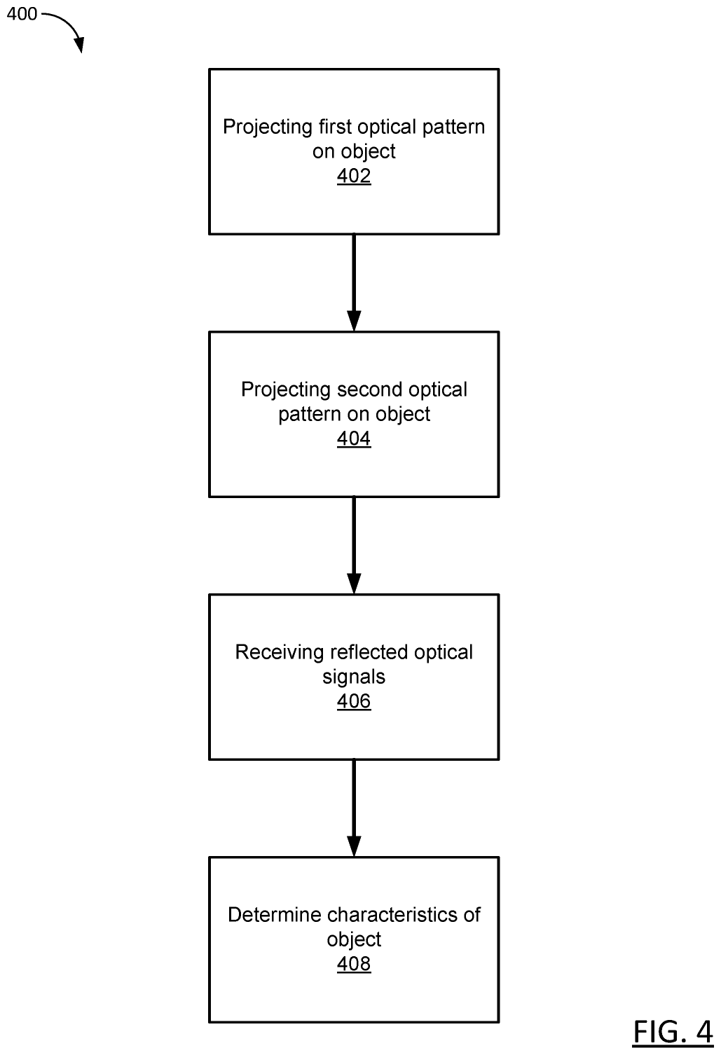

FIG. 4 illustrates an example process for operating a lidar system. The lidar system can be, for example, the lidar system 110 as described in reference to FIGS. 1A and 1B. The lidar system projects, by a transmitter, a first optical pattern having a first set of characteristics onto a surface of an object (402). For example, the transmitter(s) 112 may emit an optical signal 122a towards the target object 130. The optical signal 122a may have an optical pattern such as a dot pattern as described in reference to FIG. 3A.

The lidar system projects, by the transmitter, a second optical pattern having a second set of characteristics that are different from the first set of characteristics onto the surface of the object (404). For example, the one or more transmitters 112 may emit an optical signal 122b towards the target object 130. The optical signal 122b may have another optical pattern such as a dot pattern as described in reference to FIG. 3B, where the density of the dot is different.

The lidar system receives, by a receiver, a first reflected optical pattern representing a reflection of the first optical pattern from the surface of the object, and generates, by the receiver, first electrical signals representing the first reflected optical pattern (406). For example, a photodetector array of the one or more receivers 114 may receive a reflected optical pattern 124a that has been reflected from the target object 130. In response to receiving the reflected optical pattern 124a, the photodetector array may generate first electrical signals (e.g., currents) representing the reflected optical pattern 124a.

The lidar system receives, by the receiver, a second reflected optical pattern representing a reflection of the second optical pattern from the surface of the object, and generates, by the receiver, second electrical signals representing the second reflected optical pattern. For example, a photodetector array of the one or more receivers 114 may receive a reflected optical pattern 124b that has been reflected from the target object 130. In response to receiving the reflected optical pattern 124b, the photodetector array may generate second electrical signals (e.g., currents) representing the reflected optical pattern 124b.

The lidar system determines, by one or more processors and based on the first electrical signals and the second electrical signals, one or more characteristics of the object, wherein the one or more characteristics include range information of the object (408). For example, the processor(s) 120 may determine first range information of the target object 130 based on the first electrical signals that are generated by the first optical pattern having a higher dot density. The processor(s) 120 may then determine second range information of the object based on the second electrical signals that are generated by the second optical pattern having a lower dot density but larger dot size. The processor(s) 120 may then adjust the second range information based on the first range information.

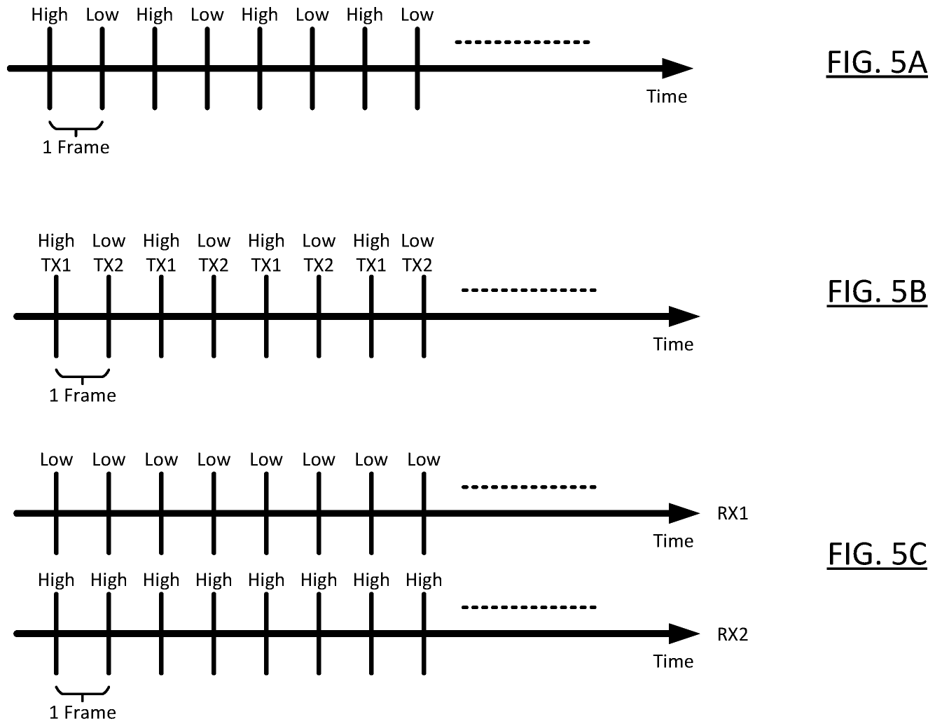

FIGS. 5A-5C illustrate examples for operating a lidar system, such as the lidar system 110 as described in reference to FIGS. 1A and 1B. FIG. 5A shows an example where the transmitter 112 may be a single source, where the diffuser 204 may be controlled to dynamically switch diffuse patterns to generate two dot patterns that alternate in time. In this example, one photodetector (or one photodetector array) of the receiver 114 receives two dot patterns that alternate in time.

FIG. 5B shows an example where the transmitter(s) 112 may include multiple (e.g., two) sources, where multiple dot patterns are emitted by the transmitter(s) at alternate times. The two sources here can operate at the same wavelength or different wavelengths. Here, the diffuser 204 may be static or be controlled dynamically to generate multiple dot patterns for each source that alternate in time. In this example, one photodetector (or one photodetector array) of the receiver 114 receives two dot patterns that alternate in time.

FIG. 5C shows an example where the transmitter(s) 112 may include multiple (e.g., two) sources, where multiple dot patterns are emitted by the transmitter(s) at the same time. The two sources here can operate at the same wavelength or different wavelengths. Here, the diffuser 204 may be static or be controlled dynamically to generate multiple dot patterns for each source that alternate in time. In this example, multiple photodetectors (or multiple regions of a photodetector array or multiple photodetector arrays) of the receiver 114 are arranged to receive corresponding optical signals as described in reference to FIG. 1B.

A number of implementations have been described. Nevertheless, it will be understood that various modifications may be made without departing from the spirit and scope of the disclosure. For example, various forms of the flows shown above may be used, with steps re-ordered, added, or removed.

Various implementations may have been discussed using two-dimensional cross-sections for easy description and illustration purpose. Nevertheless, the three-dimensional variations and derivations should also be included within the scope of the disclosure as long as there are corresponding two-dimensional cross-sections in the three-dimensional structures.

While this specification contains many specifics, these should not be construed as limitations, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments have been described. Other embodiments are within the scope of the following claims. For example, the actions recited in the claims may be performed in a different order and still achieve desirable results.

What is claimed is:

1. An optical apparatus comprising:
a transmitter configured to:
project on a surface of an object, a first optical pattern having a first set of characteristics; and
project on the surface of the object, a second optical pattern having a second set of characteristics that are different from the first set of characteristics;
a receiver configured to:
receive a first reflected optical pattern representing a reflection of the first optical pattern from the surface of the object;
generate first electrical signals representing the first reflected optical pattern;
receive a second reflected optical pattern representing a reflection of the second optical pattern from the surface of the object; and
generate second electrical signals representing the second reflected optical pattern; and
one or more processors configured to:
receive the first electrical signals and the second electrical signals; and
determine, based on the first electrical signals and the second electrical signals, one or more characteristics of the object, wherein the one or more characteristics include range information of the object.

2. The optical apparatus of claim 1, wherein the transmitter further comprises a diffuser configured to:
form the first optical pattern as a first dot pattern; and
form the second optical pattern as a second dot pattern.

3. The optical apparatus of claim 2,
wherein the first set of characteristics and the second set of characteristics include a dot density of the dot pattern,
wherein projecting the first optical pattern on the surface of the object further comprises projecting the first dot pattern on the surface, each dot of the first dot pattern having a first dot density,
wherein projecting the second optical pattern on the surface of the object further comprises projecting the second dot pattern on the surface, each dot of the second dot pattern having a second dot density, and
wherein the first dot density is higher than the second dot density, such that the first reflected optical pattern provides a higher detection range and the second reflected optical pattern provides a higher resolution.

4. The optical apparatus of claim 2,
wherein the diffuser is configured to form the first dot pattern and the second dot pattern at different time intervals,
wherein receiving the first reflected optical pattern further comprises receiving the first reflected optical pattern during a first time interval, and
wherein receiving the second reflected optical pattern further comprises receiving the second reflected optical pattern during a second time interval different from the first time interval.

5. The optical apparatus of claim 1, wherein determining the one or more characteristics of the object further comprises:
determining first range information of the object based on the first electrical signals;
determining second range information of the object based on the second electrical signals; and
adjusting the second range information based on the first range information.

6. The optical apparatus of claim 1, wherein determining the one or more characteristics of the object further comprises:
determining first range information of the object based on the first electrical signals;
determining second range information of the object based on the second electrical signals; and
selecting, based on one or more selection criteria, one of the first range information or the second range information to determine the one or more characteristics of the object.

7. The optical apparatus of claim 6, wherein the one or more selection criteria comprise a sensitivity of the receiver, a saturation level of the receiver, or a dark current of the receiver.

8. The optical apparatus of claim 1,
wherein the transmitter further comprises:
one or more first lasers configured to transmit optical signals for the first optical pattern; and
one or more second lasers configured to transmit optical signals for the second optical pattern.

9. The optical apparatus of claim 8,
wherein the one or more first lasers are configured to transmit the optical signals having a first wavelength,
wherein the one or more second lasers are configured to transmit the optical signals having a second wavelength, and
wherein the receiver further comprises:
a first pixel array configured to receive the first reflected optical pattern having the first wavelength; and
a second pixel array configured to receive the second reflected optical pattern having the second wavelength.

10. The optical apparatus of claim 8, wherein the receiver is configured to:
receive the first reflected optical pattern during a first time interval; and
receive the second reflected optical pattern during a second time interval.

11. The optical apparatus of claim 1, wherein the receiver further comprises:
a germanium-on-silicon-based pixel array configured to receive the first reflected optical pattern and the second reflected optical pattern,
wherein the germanium-on-silicon-based pixel array is formed on a silicon substrate.

12. The optical apparatus of claim 11,
wherein the receiver further comprises silicon-based circuitry formed on the silicon substrate, the silicon-based circuitry configured to generate the first electrical signals and the second electrical signals.

13. The optical apparatus of claim 11, further comprising
control circuitry formed on a silicon carrier substrate configured to control the transmitter or the receiver,
wherein the silicon carrier substrate having the control circuitry is bonded to the silicon substrate having the germanium-on-silicon-based pixel array.

14. The optical apparatus of claim 1, further comprises a scanner configured to scan optical signals transmitted by the transmitter over time to obtain a representation of a three-dimensional environment.

15. The optical apparatus of claim 14, wherein the scanner comprises a MEMS scanner.

16. A method for operating an optical apparatus, the method comprising:
projecting, by a transmitter, a first optical pattern having a first set of characteristics onto a surface of an object;
projecting, by the transmitter, a second optical pattern having a second set of characteristics that are different from the first set of characteristics onto the surface of the object;
receiving, by a receiver, a first reflected optical pattern representing a reflection of the first optical pattern from the surface of the object;
generating, by the receiver, first electrical signals representing the first reflected optical pattern;
receiving, by the receiver, a second reflected optical pattern representing a reflection of the second optical pattern from the surface of the object;
generating, by the receiver, second electrical signals representing the second reflected optical pattern; and
determining, by one or more processors and based on the first electrical signals and the second electrical signals, one or more characteristics of the object, wherein the one or more characteristics include range information of the object.

17. The method of claim 16,
wherein the first set of characteristics and the second set of characteristics include a dot density of the dot pattern,
wherein projecting the first optical pattern onto the surface of the object further comprises projecting a first dot pattern onto the surface, each dot of the first dot pattern having a first dot density,
wherein projecting the second optical pattern onto the surface of the object further comprises projecting a second dot pattern onto the surface, each dot of the second dot pattern having a second dot density, and
wherein the first dot density is higher than the second dot density, such that the first reflected optical pattern provides a higher detection range and the second reflected optical pattern provides a higher resolution.

18. The method of claim 17,
wherein projecting the first dot pattern and projecting the second dot pattern further comprises forming, by a diffuser, the first dot pattern and the second dot pattern at different time intervals,
wherein receiving the first reflected optical pattern further comprises receiving the first reflected optical pattern during a first time interval, and
wherein receiving the second reflected optical pattern further comprises receiving the second reflected optical pattern during a second time interval different from the first time interval.

19. The method of claim 18, wherein determining the one or more characteristics of the object further comprises:
determining first range information of the object based on the first electrical signals;
determining second range information of the object based on the second electrical signals; and
adjusting the second range information based on the first range information.

20. A light detection and ranging (LIDAR) device comprising:
a transmitter configured to:
project on a surface of an object, a first optical pattern having a first dot density; and
project on the surface of the object, a second optical pattern having a second dot density that is different from the first dot density;
a germanium-based receiver formed on a silicon substrate, the germanium-based receiver configured to:
receive a first reflected optical pattern representing a reflection of the first optical pattern from the surface of the object;
generate first electrical signals representing the first reflected optical pattern;
receive a second reflected optical pattern representing a reflection of the second optical pattern from the surface of the object; and
generate second electrical signals representing the second reflected optical pattern;
silicon-based control circuitry configured to control the transmitter or the germanium-based receiver; and
one or more processors configured to:
receive the first electrical signals and the second electrical signals; and
determine, based on the first electrical signals and the second electrical signals, one or more characteristics of the object, wherein the one or more characteristics include range information of the object.
